(19) United States
(12) Patent Application Publication
(10) Pub. No.: US 2005/0040039 A1
(43) Pub. Date: Feb. 24, 2005

(54) Structure of gas sensor ensuring stability of electrical joint

(75) Inventors: Takashi Kojima, Kasugai-shi (JP); Kozo Takamura, Nagoya (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Kariya-city (JP)

(21) Appl. No.: 10/923,006

(22) Filed: Aug. 23, 2004

(30) Foreign Application Priority Data
Aug. 22, 2003 (JP) 2003-299246

(51) Int. Cl. G01N 27/26

(52) U.S. Cl. 204/424

(57) ABSTRACT

An improved structure of a gas sensor is provided which is designed to ensure the reliability of electrical joints between a ceramic heater disposed in a sensor element and connector terminals for supplying electric power to the heater. The connector terminals are joined to lead wires extending outside the gas sensor to a power source. The connector terminals are elastically deformable and fitted on power supply electrodes affixed to the heater to establish electric contacts therebewteen without use of a brazing material. This permits the connector terminals and the power supply electrodes to thermally expand independently of each other when subjected to intense heat, thus resulting in almost no thermal stress on the electric contacts, which ensures the reliability of such contacts in high temperature environments.

### BACKGROUND OF THE INVENTION

1. Technical Field of the Invention

The present invention relates generally to a gas sensor which is installed, for example, in an exhaust system of automotive internal combustion engines to measure a specified component of exhaust emissions, and more particularly to an improved structure of such a gas sensor which is designed to ensure the reliability of an electrical joint in the gas sensor at increased ambient temperatures and an assembling process thereof.

2. Background Art

Typical gas sensors installed in an exhaust system (e.g., an exhaust manifold or exhaust pipe) of automotive internal combustion engines are constructed to have a bar-shaped ceramic heater installed within a cup-shaped sensor element. The ceramic heater includes an electric heating wire and is used for heating the sensor element up to a desired activation temperature thereof when the exhaust gas of the engine to be measured is low in temperature.

The heating wire is affixed to the sensor element. The sensor element has also affixed thereon power supply electrodes joined to ends of the heating wire. To the power supply electrodes, terminals installed on lead wires are joined using a brazing material such as a brazing filler metal. For example, Japanese Patent First Publication No. 2000-178078 discloses brazing materials suitable for joining ceramic bodies together or a ceramic body and a metal body together.

The power supply electrodes, the terminals of the lead wires, and the brazing material are different in the kind of material so that their coefficients of thermal expansion are different from each other. This results in a difference in degree of extension therebetween when joints of them are heated to a higher temperature, which causes thermal stress to be exerted on the joints. In the worst case, the thermal stress results in breakage of the joints.

For example, U.S. Pat. No. 6,415,647 to Yamada et al., assigned to the same assignee as that of this application, teaches joining electrodes and sensor output lines without use of the brazing material. This structure is suitable for electric connection with the gas sensor, not with the ceramic heater.

### SUMMARY OF THE INVENTION

It is therefore a principal object of the invention to avoid the disadvantages of the prior art.

It is another object of the invention to provide an improved structure of a gas sensor which is designed to ensure the reliability of electric joints between connector terminals and power supply terminals for a heater.

According to one aspect of the invention, there is provided an improved structure of a gas sensor working to measure a given component content in a gas. The gas sensor comprises: (a) a sensor element including a hollow cylindrical solid electrolyte body which has a reference gas chamber to which a reference gas is admitted, a measurement gas electrode affixed to an outer surface of the solid electrolyte body, and a reference gas electrode affixed to an inner surface of the electrolyte body to be exposed to the reference gas chamber; (b) a bar-shaped ceramic heater disposed within the reference gas chamber of the sensor element to heat the solid electrolyte body up to a given temperature; and (c) a connector terminal to which a lead wire is joined to supply electric power to the ceramic heater. The connector terminal is fitted elastically on a power supply electrode affixed to the ceramic heater.

Specifically, a joint of the power supply electrode and the connector terminal connecting with the lead wire for supplying the electric power to the heater is achieved without use of a brazing material, thus permitting the power supply electrode and the connector terminal to thermally expand independent of each other in high temperature environments. This results in almost no thermal stress on the joint of the power supply electrode and the connector terminal, thus ensuring the reliability of such a joint in high temperature environments.

In the preferred mode of the invention, the connector terminal includes a hollow cylinder which has a slit extending in a longitudinal direction of the ceramic heater and is of a C-shape in cross section. This structure is suitable for achieving the elastic fit of the connector terminal on the power supply electrode of the ceramic heater.

The ceramic heater has a cylindrical outer wall on which the power supply electrode is disposed. The connector terminal has a cylindrical inner wall contoured to conform with a contour of the outer wall of the ceramic heater. This achieves a close adhesion between the connector terminal and the power supply electrode of the ceramic heater.

The cylinder of the connector terminal may have ends which are opposed to each other across the slit and protrude outward to form guides which serve to guide action of fitting the connector terminal on the power supply electrode.

The connector terminal may be made of a heat-resisting material including one of an Ni alloy and an Fe alloy in terms of thermal durability thereof.

The connector terminal may have a portion which is placed in electric contact with the power supply electrode and plated with a noble metal in terms of thermal durability thereof.

The power supply electrode of the ceramic heater may be made of a brazing material. This results in decreased manufacturing costs of the ceramic heater.

The power supply electrode of the ceramic heater may be plated with a noble metal in terms of thermal durability.

The power supply electrode of the ceramic heater may alternatively be plated with one of Cr and Ni. This results in decreased manufacturing costs of the ceramic heater.

The connector terminal may include a hollow cylinder fitted elastically on the power supply electrode of the ceramic heater and a lead strip joined to the lead wire. The lead strip extends from the hollow cylinder along a line which is offset outside the hollow cylinder substantially.

The ceramic heater may have a recess formed in the power supply electrode. The connector terminal may have a protrusion which is fitted in the recess of the ceramic heater to establish a firm joint between the connector terminal and the power supply electrode. This avoids undesirable shift between the connector terminal and the power supply electrode.

The connector terminal may alternatively have a recess formed therein. The ceramic heater may alternatively have a protrusion formed on the power supply electrode which is fitted in the recess of the connector terminal to establish a firm joint between the connector terminal and the power supply electrode. This avoids undesirable shift between the connector terminal and the power supply electrode.

The ceramic heater also has a second power supply electrode formed thereon at an interval away from the power supply electrode in a longitudinal direction of the ceramic heater. The second power supply electrode is also connected electrically to a lead wires through a second connector terminal identical in structure with the connector terminal.

The two connector terminals may be located at an interval of lmm or more away from each other to avoid electrical contact therebetween.

The gas sensor may further comprise an insulator disposed between the connector terminals.

The ceramic heater may include a major portion and a small-diameter portion smaller in diameter than the major portion. One of the power supply electrodes is affixed to the small-diameter portion. This avoids electrical contact between the connector terminals.

According to another aspect of the invention, there is provided a method of assembling a gas sensor which comprises: (a) preparing a gas sensor including a hollow cylindrical solid electrolyte body having a reference gas chamber which has a reference gas chamber to which a reference gas is admitted, a measurement gas electrode affixed to an outer surface of the solid electrolyte body, a reference gas electrode affixed to an inner surface of the electrolyte body to be exposed to the reference gas chamber, and a bar-shaped ceramic heater disposed within the reference gas chamber of the sensor element, the bar-shaped ceramic heater having a first and a second power supply electrode formed thereon at a given interval away from each other in a longitudinal direction of the bar-shaped ceramic heater, the second power supply electrode being located farther from an end of the ceramic heater than the first power supply electrode; (b) preparing connector terminals which are to be joined to lead wires for supplying electric power to the ceramic heater through the first and second power supply electrodes; (c) covering the first power supply electrode of the ceramic heater closer to the end of the ceramic heater with an assembling jig; and (d) putting one of the connector terminals on the assembling jig from outside the end of the ceramic heater and having the one of the connector terminals slide on an outer surface of the assembling jig in the longitudinal direction of the ceramic heater so as to snap into an elastic fit on the second power supply electrode.

Specifically, the first power supply electrode closer to the end of the ceramic heater is covered with the assembling jig when one of the connector terminals is fitted on the second power supply electrode from the end of the ceramic heater, thus avoiding physical damage such as scratches to the first power supply electrode which would arise direct sliding motion of the connector terminal on the first power supply electrode toward the second power supply electrode.

According to a further aspect of the invention, there is provided a method of assembling a gas sensor which comprises: (a) preparing a gas sensor including a hollow cylindrical solid electrolyte body having a reference gas chamber which has a reference gas chamber to which a reference gas is admitted, a measurement gas electrode affixed to an outer surface of the solid electrolyte body, a reference gas electrode affixed to an inner surface of the electrolyte body to be exposed to the reference gas chamber, and a bar-shaped ceramic heater disposed within the reference gas chamber of the sensor element, the bar-shaped ceramic heater having a first and a second power supply electrode formed thereon at a given interval away from each other in a longitudinal direction of the bar-shaped ceramic heater, the second power supply electrode being located farther from an end of the ceramic heater than the first power supply electrode; (b) preparing connector terminals which are to be joined to lead wires for supplying electric power to the ceramic heater through the first and second power supply electrodes, each of the connector terminals having a hollow cylinder with a slit extending in a longitudinal direction of the hollow cylinder; and (c) placing one of the connector terminals in abutment of ends thereof opposed across the slit with an outer surface of the second power supply electrode and pressing the one of the connector terminals so as to expand the slit elastically to have the one of the connector terminals snap into a firm fit on the second power supply electrode.

Specifically, a joint of one of the connector terminals to the second power supply electrode farther from the end of the ceramic heater is achieved by fitting the connector terminal on the ceramic heater directly from a lateral direction thereof, thus avoiding physical damage such as scratches to the first power supply electrode which would arise direct sliding motion of the connector terminal on the first power supply electrode toward the second power supply electrode.

### BRIEF DESPCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view which shows a structure of a gas sensor according to the invention;

FIG. 2 is a partially enlarged view which shows electric joints between connector terminal and power supply electrodes on a ceramic heater;

FIG. 3 is a transverse sectional view which shows an elastic fit of a connector terminal on a power supply electrode of a ceramic heater;

FIG. 4 is an exploded perspective view which shows connector terminals and a ceramic heater;

FIG. 5 is a partially exploded perspective view which shows a first modification of a joint of a connector terminal and a ceramic heater;

FIG. 6 is a partially exploded perspective view which shows a second modification of a joint of a connector terminal and a ceramic heater;

FIG. 7 is a partially perspective view which shows a first modification of a structure of a ceramic heater;

FIG. 8 is a partially perspective view which shows a second modification of a structure of a ceramic heater;

FIG. 9 is a first modified form of a connector terminal;

FIG. 10 is a second modified form of a connector terminal;

FIG. 11 is a third modified form of a connector terminal;

FIG. 12 is a fourth modified form of a connector terminal;

FIG. 13 is partially perspective view which shows an assembling manner in which a connector terminal is fitted on a lower power supply terminal on a ceramic heater according to the second embodiment of the invention;

FIG. 14 is a partially longitudinal sectional view which shows a step of having a connector terminal slide on an assembling jig put on an upper power supply electrode of a ceramic heater;

FIG. 15 is a transverse sectional view of a connector terminal and a ceramic heater which shows an alternative step of fitting the connector terminal on a lower power supply terminal of the ceramic heater through snap action; and

FIG. 16 is a transverse sectional view which a connector terminal after snapping into an elastic fit on a lower power supply terminal.

### DESCRIPTION OF THE PREFERRED EMBODIMENTS

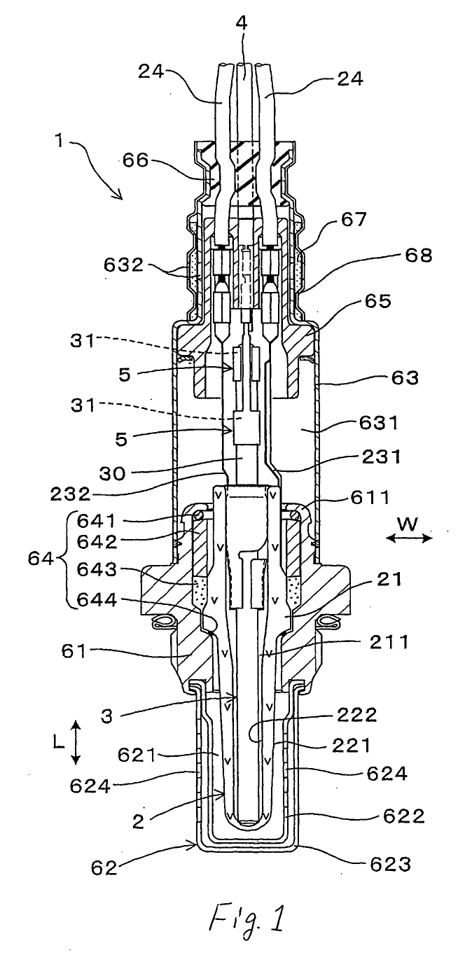

Referring to the drawings, wherein like reference numbers refer to like parts in several views, particularly to FIG. 1, there is shown a gas sensor 1 according to the first embodiment of the invention which is designed to be installed in an exhaust system of an automotive internal combustion engine to measure the concentration of a specified component such as O₂, NOx, CO, or HC of exhaust gasses for burning control of the engine.

The gas sensor 1 includes a sensor element 2 and a bar-shaped ceramic heater 3 working to heat the sensor element 2 up to a desired activation temperature thereof. The sensor element 2 is made up of a hollow cylindrical solid electrolyte body 21 with a bottom, a measurement gas electrode 221, and a reference gas electrode 222. The solid electrolyte body 21 has formed therein a reference gas chamber 211 filled with a reference gas (i.e., air). The measurement gas electrode 221 is affixed to an outer surface of the solid electrolyte body 21 and exposed to gas to be measured, which will also be referred to as a measurement gas below. The reference gas electrode 222 is affixed to a portion of an inner surface of the solid electrolyte body 21 opposed to the measurement gas electrode 221 and exposed to the reference gas within the reference gas chamber 211. The ceramic heater 3 is disposed within the reference gas chamber 211.

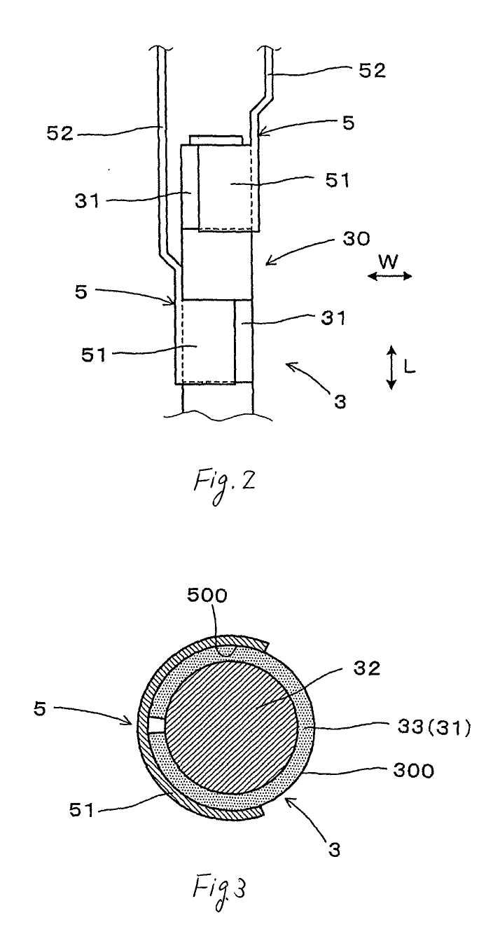

The ceramic heater 3, as clearly shown in FIGS. 2 to 4, has power supply electrodes 31 formed on the surface thereof. The power supply electrodes 31 are joined to connector terminals 5 crimped on ends of lead wires 4 for supplying electric power to the ceramic heater 3. Specifically, the connector terminals 5 are elastically fitted on the power supply electrodes 31 of the ceramic heater 3. The power supply electrodes 31 are preferably made of a brazing material such as Au—Cu, Ag—Cu, or Cu filler metal in order to reduce manufacturing costs of the ceramic heater 3. The power supply electrodes 31 may be plated with Au, Pt, or Ag in order to increase the heat resistance thereof or alternatively be plated with Cr or Ni in order to decrease manufacturing costs of the ceramic heater 3.

The ceramic heater 3 is, as can been seen from FIG. 1, inserted into the reference gas chamber 211 of the sensor element 2 from one end thereof and has at the other end a portion 30 protruding outside the reference gas chamber 211. The two power supply electrodes 31 are, as clearly shown in FIG. 2, separate from each other in a longitudinal direction L of the ceramic heater 3 and affixed to the protruding portion 30 of the ceramic heater 3. The ceramic heater 3, as clearly shown in FIG. 3, is circular in cross section. The power supply terminals 31 are affixed to an outer circumferential surface of the ceramic heater 3.

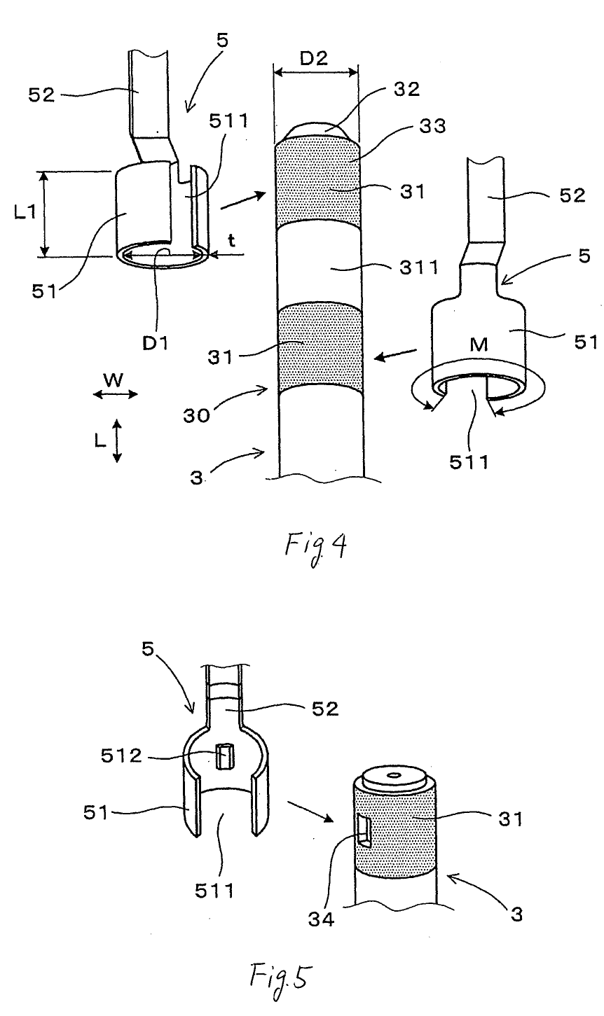

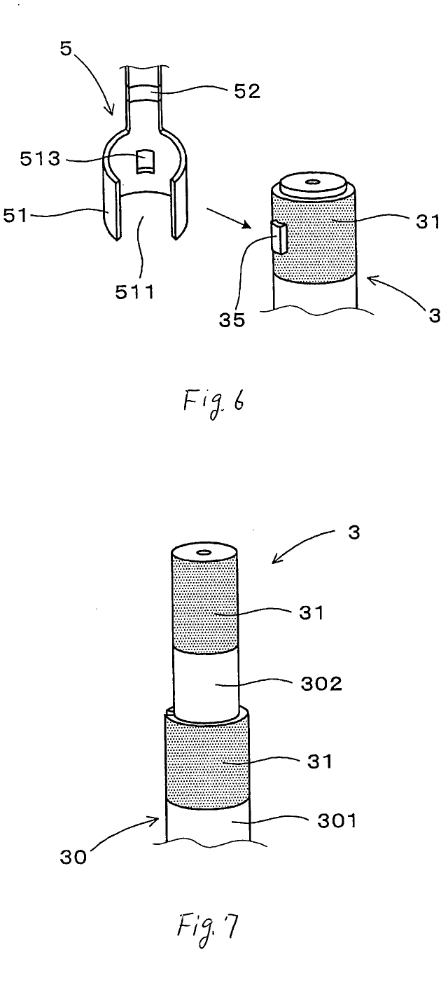

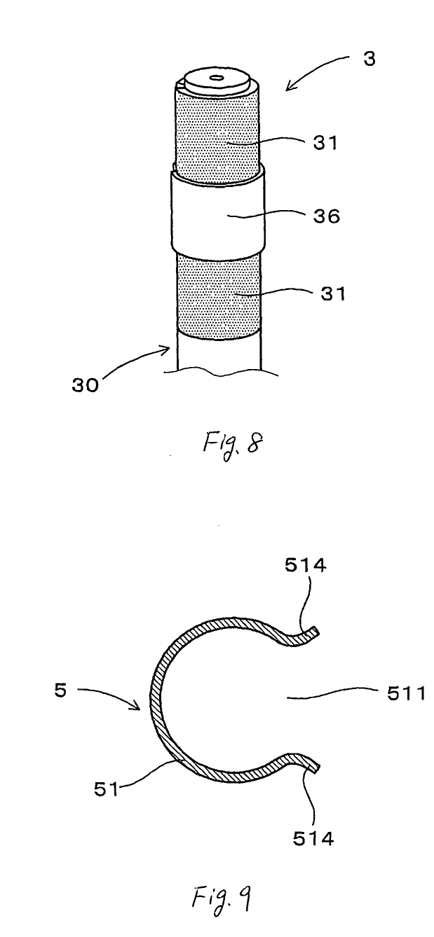

The ceramic heater 3 is, as shown in FIGS. 3 and 4, made by burning an assembly of a ceramic bar 32 and ceramic sheet 33 which is wrapped about the bar 32 and has an electric heating wire (not shown) attached thereto. The power supply electrodes 31 are formed on the ceramic bar 32 in electric connection with ends of the heating wire.

Each of the connector terminals 5 is, as shown in FIGS. 2 and 4, made up of a hollow cylindrical holder 51 and a lead strip 52. The holder 51 is designed to be fitted elastically on the electrode 31 of the ceramic heater 3. The lead strip 52 extends from an end of the holder 51 in the longitudinal direction L of the ceramic heater 3 and is to be joined to the lead wire 4 electrically. The lead strip 52 of each of the connector terminals 5 is, as clearly illustrated in FIG. 2, bent outward (i.e., a radius direction W of the terminal 5) and extends substantially parallel to the ceramic heater 3.

The cylindrical holder 51 of each of the connector terminals 5, as shown in FIGS. 3 and 4, has a slit 511 extending in the longitudinal direction L and is of C-shape in cross section. The cylindrical holder 51 is formed by bending to have an inner surface contoured to conform with the contour of the power supply terminal 31 of the ceramic heater 3.

Before fitted on the power supply terminals 31 of the ceramic heater 3, the cylindrical holders 51 of the connector terminals 5 have an inner diameter D1 smaller than an outer diameter D2 of the protruding portion 30 of the ceramic heater 3 on which the power supply terminals 31 are formed. The inner diameter D1 and the outer diameter D2 meet a relation of 0.8×D2≦D1≦0.99×D2.

Each of the cylindrical holders 51, as shown in FIGS. 3 and 4, has a circumference M enough to cover 180° or more of the periphery of the ceramic heater 3. Specifically, the circumference M meets a relation of M≧π×D2/2.

In this embodiment, the outer diameter D2 of the protruding portion 30 of the ceramic heater 3 is 2.5 to 3.5 mm. The circumference M of the cylindrical holders 51 is 6 to 8 mm. The thickness t of the connector terminals 5 is 0.1 to 0.3 mm. The length L1 of the connector terminals 5 in the longitudinal direction L is 4 to 8 mm. The inner diameter D1 of the cylindrical holders 5 before fitted on the power supply electrodes 31 is 2.6 to 3.1 mm.

The current which is higher or larger than that outputted from the electrodes 221 and 222 of the sensor element 2 flows through the ceramic heater 3. The outer diameter D2 of the protruding portion 30 of the ceramic heater 3 is smaller than the outer diameter of the sensor element 2 (e.g., 7 to 9 mm). Firm joints between the ceramic heater 3 and the connector terminals 5 may, therefore, be created by selecting values of the dimensions D1, D2, M, t, and L1 properly.

The connector terminals 5 are made of INCONEL (i.e., nickel alloy) that is a heat-resisting steel including one of an Ni alloy and an Fe alloy in terms of thermal durability. Each of the connector terminals 5 has an inner periphery 500 which is placed in abutment with a corresponding one of the power supply electrodes 31 of the ceramic heater 3. The cylindrical holder 51 of each of the connector terminals 5 may be plated with a noble metal such as Au, Pt, or Ag in order to increase the heat resistance thereof.

The gas sensor 1 has retained therein the two lead wires 4 for supplying the electric power to the ceramic heater 3. The connector terminals 5 have the lead strips 52 joined to the ends of the lead wires 4, respectively, thereby establishing electrical joints between the lead wires 4 and the power supply electrodes 31 of the ceramic heater 3. Specifically, the power supply electrodes 31 are supplied with the electric power through the lead wires 4 to have the current flow through the heating wire of the ceramic heater 3, so that the ceramic heater 3 is elevated in temperature to heat the sensor element 2.

In order to avoid physical contact between the connector terminals 5, the power supply electrodes 31 are located on the ceramic heater 3 at an interval of 1 mm or more away from each other. The connector terminals 5 are also fitted on the ceramic heater 3 at an interval of 1 mm or more away from each other.

The fitting of the connector terminals 5 on the power supply electrodes 31 of the ceramic heater 3 is easily achieved by expanding the slits 511 of the cylindrical holders 51 elastically and putting the cylindrical holders 51 on the power supply electrodes 31. The cylindrical holders 51 elastically contract to create press-fits on the power supply electrodes 31, thereby establishing close adhesions or electrical contacts between the inner surfaces 500 of the cylindrical holders 51 and the power supply electrodes 31 on the outer surface 300 of the ceramic heater 3. This results in a decreased electric resistance at the contacts between the connector terminals 5 and the power supply electrodes 31.

The entire structure of the gas sensor 1 will be explained below in brief.

Referring back to FIG. 1, the gas senor 1 includes a hollow cylindrical housing 61 in which the sensor element 2 is retained, a measurement gas-exposed cover assembly 62 joined to an end of the housing 61, and an air-exposed cover 63 welded to the other end of the housing 61. The measurement gas-exposed cover assembly 62 has defined therein a measurement gas chamber 621 to which the measurement gas (i.e., the exhaust gas of the engine) is admitted and the sensor element 2 is exposed. The air-exposed cover 63 has defined therein a reference gas chamber 631 communicating with the reference gas chamber 211 in the sensor element 2.

The sealing parts 64 are disposed between the inner wall of the housing 61 and the outer wall of the sensor element 2. The sensor element 2 is retained firmly within the housing 61 by crimping or bending an annular extension 611 of the housing 61 inwardly to press the sensor element 2 through the sealing parts 64 against the inner wall of the housing 61. The sealing parts 64 are a metal ring 641, an insulator 642, a powder seal 643 made of talc etc., and a metal gasket 644. The insulator 642 works to insulate the sensor element 2 from the housing 61 electrically. The metal ring 641 is disposed between the annular extension 611 and the insulator 642 in abutment therewith to achieve a hermetical seal therebetween. The metal gasket 644 is disposed between an outer annular tapered shoulder of the sensor element 2 and an inner annular tapered shoulder of the housing 61 to enhance adhesion therebetween.

Disposed within the air-exposed cover 63 are a porcelain insulator 65 and a rubber bush 66. The rubber bush 66 has the lead wires 4 and 24 retained therein. The lead wires 24 are connected to sensor output lines 231 and 232 through connectors within the porcelain insulator 65. The sensor output lines 231 and 232 are connected to the electrodes 221 and 222 affixed to the sensor element 2. The lead wires 4 and 24 extend outside the rubber bush 66 and joined to an external sensor controller (not shown). The power supply electrodes 31 of the sensor element 2 are joined to the lead wires 4 through the connector terminals 5 within the porcelain insulator 65.

The air-exposed cover 63 has formed therein air vents 632 through which the reference gas or air enters the reference gas chamber 631. A cylindrical water-repellent filter 67 is disposed around the air vents 632. An outer cover 68 is affixed to a small-diameter portion of the air-exposed cover 63. Such affixing is achieved by crimping the outer cover 68, thereby also retaining the filter 67 between the outer cover 68 and the air-exposed cover 63. The outer cover 68 also has air vents 632 communicating with the air vent 632 of the air-exposed cover 63 through the filter 67.

The air, as used as the reference gas in the sensor element 2, enters the air vents 632 from outside the gas sensor 1 and flows into the reference gas chamber 211 within the sensor element 2 through the reference gas chamber 631 within the air-exposed cover 63.

The measurement gas-exposed cover assembly 62 is, as described above, installed at an end thereof in an annular groove formed in the bottom of the housing 61. The measurement gas-exposed cover assembly 62 is made up of an inner cover 622 and an outer cover 623 both of which have gas inlets 624 through which the measurement gas is admitted into the measurement gas chamber 621 to which the sensor element 2 is exposed.

The electric joints between the power supply electrodes 31 of the ceramic heater 3 and the lead wires 4 are, as described above, established without use of a brazing material. Specifically, such joints are accomplished by elastically fitting the connector terminals 5 on the power supply electrodes 31. Therefore, when the joints of the connector terminals 5 to the power supply electrodes 31 are elevated in temperature, the power supply electrodes 31 and the connector terminals 5 thermally expand independently of each other. In other words, the connector terminals 5 are elastically deformed while keeping the electric joints with the power supply electrodes 31 as they are, thus resulting in almost no thermal stress on the connector terminals 5 and the power supply electrodes 31. This ensures the reliability of the electrical joints between the connector terminals 5 and the power supply electrodes 31 of the ceramic heater 3 even when the gas sensor 1 is exposed to intense heat.

In order to avoid undesirable slippage between the ceramic heater 3 and the connector terminals 5, they may have structural features, as shown in FIG. 5.

Specifically, each of the connector terminals 5 has a protrusion 512 formed on the inner wall thereof. Each of the power supply electrodes 31 has a recess 34 formed therein. When the cylindrical holder 51 is fitted on the power supply electrode 31, it results in physical engagement of the protrusion 512 with the recess 34, thereby holding the connector terminal 5 from slipping on the power supply electrode 31 in either of the longitudinal direction L and the radius direction W of the ceramic heater 3.

Alternatively, each of the connector terminals 5, as shown in FIG. 6, may have a recess 513 formed in the inner wall thereof. Each of the power supply electrodes 31 may have a protrusion 35 formed thereon. When the cylindrical holder 51 is fitted on the power supply electrode 31, it results, like in FIG. 5, physical engagement of the protrusion 35 with the recess 513, thereby holding the connector terminal 5 from slipping on the power supply electrode 31 in either of the longitudinal direction L and the radius direction W of the ceramic heater 3.

The protruding portion 30 of the ceramic heater 3, as illustrated in FIG. 7, may alternatively be made up of a large-diameter section 301 and a small-diameter section 302 continuing from the large-diameter section 301. The sections 301 and 302 have the power supply electrodes 31 affixed thereto, respectively. This structure facilitates the avoidance of electrical contact between the power supply electrodes 31 and also permits the cylindrical holders 51 of the connector terminals 5 to slide on the ceramic heater 3 in the longitudinal direction thereof and to be fitted on the power supply electrodes 31.

Alternatively, the protruding portion 30 of the ceramic heater 3, as illustrated in FIG. 8, may also have an insulator collar 36 fitted between the power supply electrodes 31 in order to avoid a longitudinal shift of the cylindrical holders 51 of the connector terminals 5.

The cylindrical holder 51 of each of the connector terminals 5 may be designed to have one of shapes in cross section, as illustrated in FIGS. 9 to 12. Specifically, the cylindrical holder 51 has outward curled or bent ends 514 between which the slit 511 is formed.

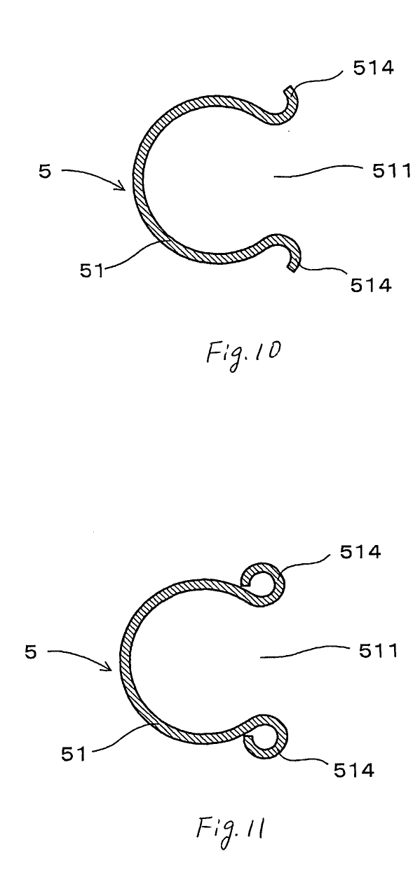

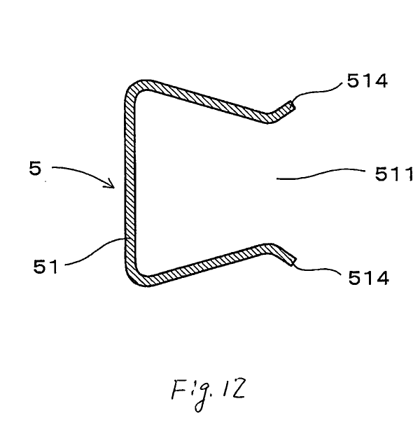

In FIGS. 9 and 12, the ends 514 are oriented substantially in the radius direction W of the holders 51. In FIGS. 10 and 11, the ends 514 are curled outward to have a semi-circular or complete circular cross section.

The holders 51, as shown in FIG. 12, may be rectangular in cross section.

The curled or bent ends 514 serve as guides to facilitate fitting of the holders 51 on the power supply electrodes 31 of the ceramic heater 3 from a lateral direction of the ceramic heater 3. Specifically, the fitting of each of the holders 51 on the power supply electrode 31 is achieved easily by placing the holder 51 in abutment of the ends 514 with the outer wall of the ceramic heater 3 and pressing the holder 51 to expand the slit 511.

The assembling of the gas sensor 1, especially a manner in which the connector terminals 5 are fitted on the power supply electrodes 31 of the ceramic heater 3 will be described below as the second embodiment of the invention.

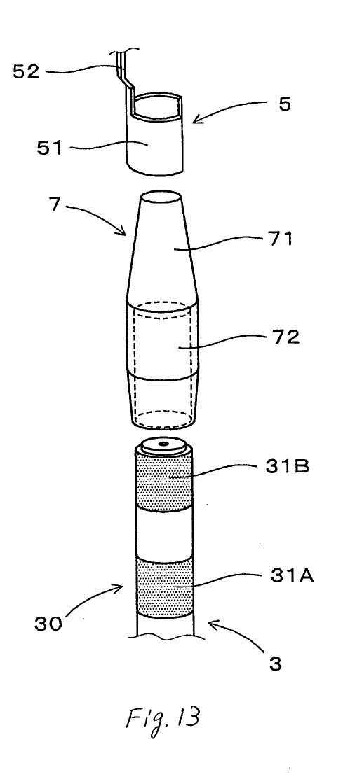

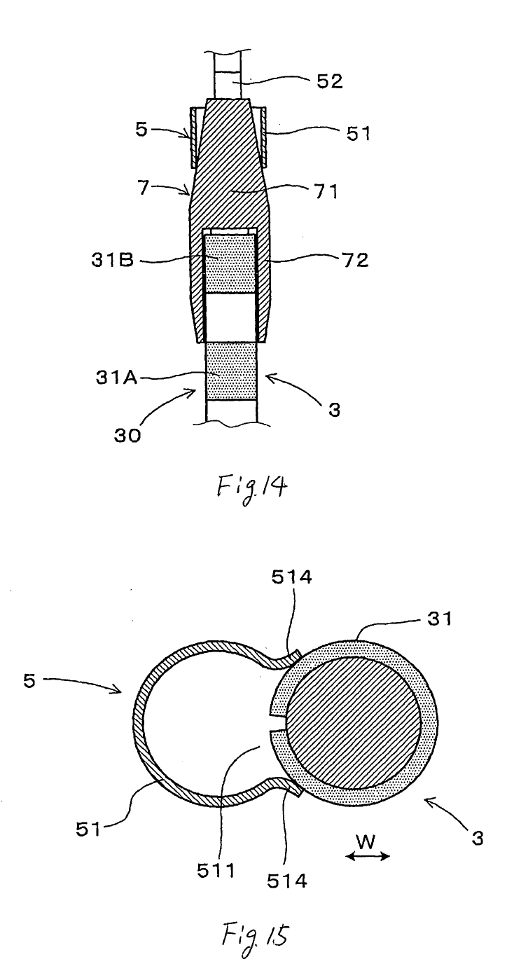

The assembling of this embodiment serve to fit the cylindrical holder 5 on the lower power supply electrode 31A closer to the sensor element 2, as illustrated in FIG. 13, without any damage such as scratches on the upper power supply electrode 31B closer to a base end of the ceramic heater 3 (i.e., an upper side, as viewed in FIG. 1).

In order to avoid scratches on the upper power supply electrode 31B, an assembling jig 7 is used which covers, as clearly shown in FIG. 14, the upper power supply electrode 31B fully and also serves to facilitate ease of sliding motion of the cylindrical holder 51 toward the lower power supply electrode 31A. The assembling jig 7 is made of a cylinder which has a tapered outer wall 71 and a vertically extending straight outer wall 72. The tapered outer wall 71 has the outer diameter at a tip end thereof which is smaller than the inner diameter D1 (see FIG. 4) of the cylindrical holders 51 of the connector terminals 5 before fitted on the power supply electrodes 31 and servers to facilitate ease of fitting of the holder 51 on the straight outer wall 72. The straight outer wall 72 serves to allow the holder 51 to slide smoothly toward the lower power supply electrode 31A.

The fitting of the cylindrical holder 51 on the lower power supply electrode 31A is, as shown in FIG. 14, achieved by putting the assembling jig 71 on the end of the ceramic heater 3 to cover the upper power supply electrode 31B fully and inserting the tapered outer wall 71 into the cylindrical holder 51 of the connector terminal 5 to expand the cylindrical holder 51 elastically outward and to have the cylindrical holder 51 slide on the tapered outer wall 71 and the straight outer wall 72 without any physical contact with the upper power supply electrode 31B. The lower end of the straight outer wall 72 extends, as clearly shown in FIG. 14, to the upper end of the lower power supply electrode 31A. Thus, at a time when the cylindrical holder 51 slides beyond the straight outer wall 72, it is allowed to snap into firm engagement with the lower power supply electrode 31A.

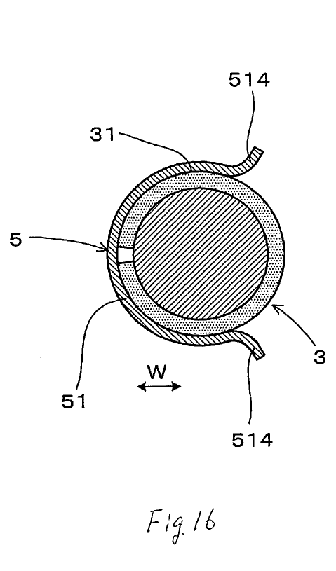

The fitting of the connector terminal 5 on the lower power supply electrode 31A may alternatively be accomplished without any damage to the upper power supply electrode 31A in a manner, as illustrated in FIG. 15.

Specifically, the connector terminal 5 is, as can be seen from the drawing, first placed in abutment of the ends 514 thereof with the outer surface of the lower power supply electrode 31A and then pressed in the radius direction W of the ceramic heater 3 to elastically expand the slit 511 outward until the cylindrical holder 51, as illustrated in FIG. 16, snaps into fit on the lower power supply electrode 31A. This manner ensures the firm fitting of the connector terminal 5 on the lower power supply electrode 31A without having it slide over the upper power supply electrode 31B which will result in scratches on the upper power supply electrode 31B.

Instead of the connector terminal 5, as illustrated in FIGS. 15 and 16, the one, as illustrated in FIGS. 10, 11, or 12 may be employed.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

1. A gas sensor comprising:
a sensor element including a hollow cylindrical solid electrolyte body which has a reference gas chamber to which a reference gas is admitted, a measurement gas electrode affixed to an outer surface of said solid electrolyte body, and a reference gas electrode affixed to an inner surface of said electrolyte body to be exposed to the reference gas chamber;
a bar-shaped ceramic heater disposed within the reference gas chamber of said sensor element to heat the solid electrolyte body up to a given temperature; and
a connector terminal to which a lead wire is joined to supply electric power to said ceramic heater, said connector terminal being fitted elastically on a power supply electrode affixed to said ceramic heater.

2. A gas sensor as set forth in claim 1, wherein said connector terminal includes a hollow cylinder which has a slit extending in a longitudinal direction of said ceramic heater and is of a C-shape in cross section.

3. A gas sensor as set forth in claim 1, wherein said ceramic heater has a cylindrical outer wall on which the power supply electrode is disposed, and wherein said connector terminal has a cylindrical inner wall contoured to conform with a contour of the outer wall of said ceramic heater.

4. A gas sensor as set forth in claim 2, wherein said cylinder of said connector terminal has ends which are opposed across the slit and protrude outward to form guides which serve to guide action of fitting the connector terminal on the power supply electrode.

5. A gas sensor as set forth in claim 1, wherein said connector terminal is made of a heat-resisting material including one of an Ni alloy and an Fe alloy.

6. A gas sensor as set forth in claim 1, wherein said connector terminal has a portion which is placed in electric contact with the power supply electrode and plated with a noble metal.

7. A gas sensor as set forth in claim 1, wherein the power supply electrode of said ceramic heater is made of a brazing material.

8. A gas sensor as set forth in claim 1, wherein the power supply electrode of said ceramic heater is plated with a noble metal.

9. A gas sensor as set forth in claim 1, wherein the power supply electrode of said ceramic heater is plated with one of Cr and Ni.

10. A gas sensor as set forth in claim 1, wherein said connector terminal includes a hollow cylinder fitted elastically on the power supply electrode of said ceramic heater and a lead strip joined to the lead wire, the lead strip extending from the hollow cylinder along a line which is offset outside the hollow cylinder substantially.

11. A gas sensor as set forth in claim 1, wherein said ceramic heater has a recess formed in the power supply electrode, and said connector terminal has a protrusion which is fitted in the recess of said ceramic heater to establish a firm joint between the connector terminal and the power supply electrode.

12. A gas sensor as set forth in claim 1, wherein said connector terminal has a recess formed therein, and said ceramic heater has a protrusion formed on the power supply electrode which is fitted in the recess of said connector terminal to establish a firm joint between the connector terminal and the power supply electrode.

13. A gas sensor as set forth in claim 1, wherein said ceramic heater also has a second power supply electrode formed thereon at an interval away from the power supply electrode in a longitudinal direction of said ceramic heater, the second power supply electrode being also connected electrically to a lead wires through a second connector terminal identical in structure with the connector terminal.

14. A gas sensor as set forth in claim 13, wherein said connector terminals are located at an interval of 1 mm or more away from each other.

15. A gas sensor as set forth in claim 13, further comprising an insulator disposed between said connector terminals.

16. A gas sensor as set forth in claim 13, wherein said ceramic heater includes a major portion and a small-diameter portion smaller in diameter than the major portion, one of said power supply electrodes being affixed to the small-diameter portion.

17. A method of assembling a gas sensor comprising:
preparing a gas sensor including a hollow cylindrical solid electrolyte body having a reference gas chamber which has a reference gas chamber to which a reference gas is admitted, a measurement gas electrode affixed to an outer surface of said solid electrolyte body, a reference gas electrode affixed to an inner surface of said electrolyte body to be exposed to the reference gas chamber, and a bar-shaped ceramic heater disposed within the reference gas chamber of said sensor element, the bar-shaped ceramic heater having a first and a second power supply electrode formed thereon at a given interval away from each other in a longitudinal direction of the bar-shaped ceramic heater, the second power supply electrode being located farther from an end of the ceramic heater than the first power supply electrode;
preparing connector terminals which are to be joined to lead wires for supplying electric power to the ceramic heater through the first and second power supply electrodes;
covering the first power supply electrode of the ceramic heater closer to the end of the ceramic heater with an assembling jig; and
putting one of the connector terminals on the assembling jig from outside the end of the ceramic heater and having the one of the connector terminals slide on an outer surface of the assembling jig in the longitudinal direction of the ceramic heater so as to snap into an elastic fit on the second power supply electrode.

18. A method of assembling a gas sensor comprising:
preparing a gas sensor including a hollow cylindrical solid electrolyte body having a reference gas chamber which has a reference gas chamber to which a reference gas is admitted, a measurement gas electrode affixed to an outer surface of said solid electrolyte body, a reference gas electrode affixed to an inner surface of said electrolyte body to be exposed to the reference gas chamber, and a bar-shaped ceramic heater disposed within the reference gas chamber of said sensor element, the bar-shaped ceramic heater having a first and a second power supply electrode formed thereon at a given interval away from each other in a longitudinal direction of the bar-shaped ceramic heater, the second power supply electrode being located farther from an end of the ceramic heater than the first power supply electrode;
preparing connector terminals which are to be joined to lead wires for supplying electric power to the ceramic heater through the first and second power supply electrodes, each of the connector terminals having a hollow cylinder with a slit extending in a longitudinal direction of the hollow cylinder; and
placing one of the connector terminals in abutment of ends thereof opposed across the slit with an outer surface of the second power supply electrode and pressing the one of the connector terminals so as to expand the slit elastically to have the one of the connector terminals snap into a firm fit on the second power supply electrode.
